(19) United States
(12) Patent Application Publication
(10) Pub. No.: US 2012/0137289 A1
(43) Pub. Date: May 31, 2012

(54) PROTECTING HIGH PRIORITY WORKLOADS IN A VIRTUALIZED DATACENTER

(75) Inventors: Michael H. Nolterieke, Raleigh, NC (US); William G. Pagan, Durham, NC (US); Edward S. Suffern, Chapel Hill, NC (US)

(73) Assignee: INTERNATIONAL BUSINESS MACHINES CORPORATION, Armonk, NY (US)

(21) Appl. No.: 12/956,019

(22) Filed: Nov. 30, 2010

(51) Int. Cl. G06F 9/455

(52) U.S. Cl. 718/1

(57) ABSTRACT

A computer program product is provided, including computer usable program code for running a plurality of virtual machine workloads across a plurality of servers within a common power domain, and computer usable program code for setting an operating level for each of a plurality of hardware resources within the common power domain in response to receiving an early power off warning from a power source that supplies power to the common power domain, wherein the operating level for each of the hardware resources is determined as a function of the priority of the virtual machine workloads that are utilizing each of the hardware resources.

### BACKGROUND

1. Field of the Invention

The present invention relates to the management of virtual machines. More specifically, the present invention relates to management of virtual machines and system resources used by the virtual machines during a loss of power.

2. Background of the Related Art

In a cloud computing environment, a job, application or other workload is assigned a virtual machine somewhere in the computing cloud. The virtual machine provides the software operating system and has access to physical resources, such as input/output bandwidth, processing power and memory capacity, to support the virtual machine in the performance of the workload. Provisioning software manages and allocates virtual machines among the available compute nodes in the cloud. Because each virtual machine runs independent of other virtual machines, multiple operating system environments can co-exist on the same physical computer in complete isolation from each other.

Unexpected power failures can cause significant loss of data in such a computing environment. Backup power generators and battery backup systems can be implemented to limit the occurrence of complete power failures or provide supplementary power to allow a smooth shutdown of system resources, but such system are expensive to install and maintain. Furthermore, these systems have their own limitations and failures, such that the potential for a power loss is never completely eliminated.

### BRIEF SUMMARY

One embodiment of the present invention provides a computer program product including computer usable program code embodied on a computer usable storage medium. The computer program product comprises computer usable program code for running a plurality of virtual machine workloads across a plurality of servers within a common power domain, and computer usable program code for setting an operating level for each of a plurality of hardware resources within the common power domain in response to receiving an early power off warning from a power source that supplies power to the common power domain, wherein the operating level for each of the hardware resources is determined as a function of the priority of the virtual machine workloads that are utilizing each of the hardware resources.

### BRIEF DESCRIPTION OF THE SEVERAL VIEWS OF THE DRAWINGS

FIG. 1 is a diagram of a computer that may be utilized in accordance with the present invention.

FIG. 2 is a diagram of a multi-server chassis that may be utilized in accordance with the present invention.

FIG. 3 is a diagram of the multi-server chassis of FIG. 2 including a power supply and illustrating an example of a virtual machine data table and EPOW response policy maintained by the chassis management controller.

FIG. 4 is a virtual machine data table according to one embodiment.

FIG. 5 is a table showing a weighted criticality calculation consistent with the embodiment of FIG. 4.

FIG. 6 is a table showing EPOW responses consistent with the embodiment of FIGS. 4 and 5.

FIG. 7 is a flowchart of one embodiment of a method of the present invention.

### DETAILED DESCRIPTION

One embodiment of the present invention provides a computer program product including computer usable program code embodied on a computer usable storage medium. The computer program product comprises computer usable program code for running a plurality of virtual machine workloads across a plurality of servers within a common power domain. In addition, the computer program product comprises computer usable program code for setting an operating level for each of a plurality of hardware resources within the common power domain in response to receiving an early power off warning from a power source that supplies power to the common power domain, wherein the operating level for each of the hardware resources is determined as a function of the priority of the virtual machine workloads that are utilizing each of the hardware resources.

In one embodiment, the plurality of servers are operable within a multi-server chassis, such as an IBM BLADECENTER (IBM and BLADECENTER are trademarks of International Business Machines Corporation of Armonk, N.Y.). In a multi-server chassis, a chassis management controller may have a primary role in the implementation of the present invention, for example by running at least a portion of the computer program product described herein. Optionally, the invention may be implemented across more than one multi-server chassis by running a separate instance of at least a portion of the computer program in the chassis management controller of each multi-server chassis. Alternatively, at least a portion of the computer program product may be implemented in a remote management node, such as an IBM DIRECTOR SERVER (IBM and DIRECTOR SERVER are trademarks of International Business Machines Corporation of Armonk, N.Y.).

A power domain may be defined by the scope of hardware resources that receive power from a common power source, such as a power supply. However, there may be more than one power domain within a computer system. Multiple power domains may be independent or interdependent. In a multi-server chassis, the plurality of servers within the chassis may be considered to be within a common power domain because each of those servers relies upon the same one or more power supplies that are internal to the chassis. Failure of the source of power to the chassis or failure of any one power supply within the chassis will affect the availability of power within the chassis. It should also be recognized that there can be multiple power domains within a chassis or within a single server if some devices are powered by one power source and other devices are run by another power source.

The hardware resources within a server may vary from one server to another according to its configuration. The methods of the present invention are not limited to any group or type of hardware resources, but preferably includes any hardware resource with operating levels that can be independently controlled, such as through a software or firmware interface. For example, the operating levels of I/O, storage devices, memory and processors may be controlled on a typical server.

Power supplies are currently available that will issue an early power off warning (EPOW) when they detect a power failure. Embodiments of the present invention communicate the EPOW from a power supply to a management controller, such as the chassis management controller. After a power failure, the power supply will attempt to run for as long as possible off of stored capacitance. However, the capacitance of the power supply(ies) during a power failure is very rapidly depleted. Embodiments of the present invention extend the length of time that critical workloads may continue to run before total power loss on the systems. Preferably, a chassis management controller will take action before the power is exhausted, such as flushing cached data and attempting to shut the server down gracefully.

The priority of the virtual machine workloads that are utilizing each of the hardware resources may be manually input by a user or dynamically determined, for example by either the chassis management controller or a management controller on an individual server. The form of the priority may be an independently determined scaled value (i.e., from 0 for a low priority to 10 for a high priority), or perhaps a rank (i.e., 1^{st}, 2^{nd}, 3^{rd}, etc.). The priority of a workload may be objectively determined, such as based upon the type of application, and/or determined automatically, optionally based upon whether the workload is active or idle, the number of users that the workload is servicing, the specific users that the workload is servicing, and the like. However, regardless of how the priority is quantified or expressed, the priority is uniquely associated with a particular workload and maintains that association with the particular workload even if the workload is migrated to another server. Embodiments of the invention use this workload-specific prioritization, immediately following a negative power event, to allocate the limited amount of available power among hardware resources that are running high priority workloads. Embodiments of the invention may also prioritize critical emergency shutdown procedures that may not be part of a virtual machine workload, such as a hard drive that may be vulnerable to total failure if it is not properly shutdown. As such, the EPOW response policy may be more lenient with that resource, allowing it to stay on longer than another resource that is more fault tolerant. Alternatively, the EPOW response policy may still allow a potentially damaging hard shutdown of a resource if the cost of that hardware is cheap, or if the power domain also includes a resource that is even more expensive that could be damaged if it doesn't get the extra power to shutdown. Embodiments of the EPOW response policy may, for any given resource, be influenced by the given resource's tolerance to an unplanned power outage.

The operating level of each hardware resource may be static or dynamic during normal operation of the system, but most hardware resources can be put into more than one operating level through a software or hardware interface. For example, a management entity that observes the EPOW warning and determines the operating level of the hardware resource according to an EPOW response policy may issue an ACPI command or other type of command to put the resource in a new power state. However, embodiments of the invention will control and/or change the operating level in response to receiving an EPOW signal from a power supply. For example, the operating level for at least one of the hardware resources may be set to a shutdown, such as a hard shutdown, in response to determining that the at least one of the hardware resources is not utilized by a high priority virtual machine workloads. This type of action or other decrease in the operating level of a hardware resource serves to conserve power that is then made available to other hardware resources that are being utilized by a high priority virtual machine workload. In a further example, the operating level for at least one of the hardware resources may be increased, such as by disabling processor throttling, in response to determining that the at least one of the hardware resources is being utilized by a high priority virtual machine workload. Disabling throttling, or any other action to increase the operating level of a hardware resource, allows critical hardware to consume as much power as is necessary to ensure that system clean-up activities (such as cache-flushing) happens as quickly as possible (i.e., consumes the stored power on behalf of high priority workloads before other devices in the power domain have the opportunity to do so). In particular, this may occur in situations where it is more efficient to put one CPU at full speed than to have two CPUs operating.

It should be recognized that if the operating level is decreased for at least one hardware resource that is not being utilized by a high priority workload, it may not be necessary or desirable to also increase the operating level of at least one other hardware resource that is being utilized by a high priority workload. Optionally, the power that would be consumed by the increased operating level might be more efficiently utilized by increasing the duration that the hardware resource could stay powered on. Since every device or hardware resource has optimal efficiency at some operating level between full-powered and full-throttled, it may be preferred for each hardware resource being utilized by a high priority workload to run at an operating level that is at or near the optimal efficiency for each individual resource.

Another embodiment further comprises computer usable program code for determining, for each of the virtual machine workloads, an extent of utilization of each of the hardware resources utilized. An extent of utilization for a given hardware resource may be input by the user on a workload-by-workload basis, may be a static utilization based on the type of workload, or may be dynamically determined on the basis of current utilization data attributable to the workload. In a first example, an extent of utilization is based on the type of workload, such that a backup workload has a storage device utilization of 10 (a scaled value from 0 for low to 10 for high), an I/O utilization of 0, a processor utilization of 2, and a memory utilization of 2. Continuing with the same example, a database workload may, by comparison, have a storage device utilization of 10, an I/O utilization of 10, a processor utilization of 2, and a memory utilization of 2. In alternative embodiments, the extent of utilization may be quantified in absolute terms, such as processor utilization quantified in millions of instructions per second (MIPS) or a I/O utilization of 1 gigabits per second (Gbps). The latter absolute quantities may be more readily available in embodiments where the extent of utilization is dynamically determined, such as where the I/O utilization (i.e., bandwidth) of a given workload is determined by querying the management information base (MIB) of a high speed network switch. An EPOW response policy that determines hardware operating levels with consideration for the extent of workload utilization may be beneficial because, for example, if a workload is heavily utilizing a hard disk drive then the workload will require continued access to the disk in order to complete a full dump of its critical memory contents to storage. As another example, a workload that performs huge block transfers through I/O might be prioritized over workloads that perform lots of small transfers because those huge blocks will be lost unless they are shipped in their entirety. By contrast, a small block being lost may be less significant.

In yet another embodiment, the operating level for a given one of the plurality of hardware resources is a function of both (a) the priority of virtual machine workloads utilizing the given hardware resource and (b) the extent of utilization of the given hardware resource by the virtual machine workloads. In such an embodiment, a hardware resource with be set to a very high operating level if a high priority workload is making heavy utilization of the hardware resource. For example, if a first workload has a priority of 10 (on a scale of 0 for low to 10 for high) and has a processor utilization of 10 (on a scale of 0 for low to 10 for high), then the processor operating level will set very high, such as unthrottling the processor. It should be recognized that a second workload with a low priority, such as a 1 or 2, or a low processor utilization, such as a 1 or 2, will not have a strong influence on the processor operating level. If the second workload is using the same (first) processor as the first workload, then the second workload may benefit from the high processor operating level that is attributable to the high priority and high utilization by the first workload. On the other hand, if the second workload is running on a second processor where there is no high priority/high utilization workload, then the second processor may be throttled or shutdown. While this lower operating level of the second processor may prevent the second workload from completing its processes, this action is intended to benefit the first workload by preserving power that can be used by the first processor to continue or complete operation of the first workload.

In a still further embodiment, the operating level for a given one of the plurality of hardware resources is a function of: (a) the priority of virtual machine workloads utilizing the given hardware resource, (b) the extent of utilization of the given hardware resource by the virtual machine workloads; and (c) the fault tolerance of the given hardware resource.

In various embodiments, the system attempts to maintain power to any hardware resource that a high priority workload may need in order to clean up safely. For example, if a hard disk drive is not currently being accessed, but the workload may need to flush data to disk before total power loss, then the system may attempt to keep the hard disk drive available to the workload to whatever extent it is practicable. Similarly, the system may attempt to maintain power to other dependent resources, such as a RAID adapter, or I/O card in a storage area network (SAN) solution. A host OS/hypervisor is generally aware of the hardware resources that a workload can access or is currently utilizing. This information can be shared with a management controller. In other embodiments, access to hardware is provided by an embedded hypervisor that is also a management processor. In still other embodiments, the use of certain hardware in the chassis is provided explicitly through configuration of the management controller, and thus that resource is necessarily known to the management controller.

In accordance with various embodiments, it should be recognized that the operating level of a given hardware resource may be ultimately determined by either a very small number of high priority workloads utilizing that hardware resource, or a group of lower priority workloads. When an EPOW is received, the management controller may, for example, attempt to do as much good as possible. In a very simple case, the management controller may save one absolutely critical workload (i.e., the highest priority workload). Alternatively, the management controller could save lots of menial workloads that have very small power demands. Still further, the management controller might try to save both types of workloads if there is sufficient expected power to handle them all. However, in response to an imminent power loss, a good quick approximation of which workloads can be handled may be as good as or better than trying to reach an optimal solution. Still further, the management controller might be continuously or periodically determining how to respond to an EPOW so that a set of instructions is ready at all times. Regardless of whether the response is an approximation or an optimization, and regardless of whether the response is predetermined or not, the management controller may use the virtual machine workload priorities to determine which hardware resources get to stay on, and the operating level at which those hardware resources should be set.

In a specific example, storage on rotating media is notoriously prone to failure on power outages. Therefore, a management controller might implement an EPOW response policy that favors rotating media to power down cleanly in order to avoid physical disk damage. Alternatively, the management controller might implement an EPOW response policy that favors disks staying up as long as possible to allow every opportunity for caches to be flushed. The latter type of policy may risk damage to a disk, but if the disk is part of a RAID array, then the benefit of saving the data may outweigh the cost of occasionally damaging an inexpensive disk.

In a still further embodiment the computer usable program code for setting an operating level for each of a plurality of hardware resources further comprises computer usable program code for determining an amount of power remaining, selecting one or more of the highest priority virtual machine workloads that can be completed with the amount of power remaining, and setting a low operating level for each of the plurality of hardware resources within the compute node that are not running the selected virtual machine workloads.

A further embodiment includes computer usable program code for determining that the priority of a workload has changed. As with the original priority of a workload, a new priority may be manually input by a user or dynamically determined, for example in response to a change in the operation of the workload. In a first option, the priority of the workload may be reduced in response to determining that the hardware resources required or typically used by the workload are in an idle state. This condition would indicate that the workload itself is not active and that the workload should not have a large influence in determining which resources should continue operation. Conversely, in a second option, the priority of the workload may be increased in response to determining that the hardware resources executing the workload are in a high utilization state. For example, high utilization may indicate a high number of workloads will be vulnerable to data loss if power is removed. In a third option, the current utilization is not helpful, since an application that will be shutdown when a shutdown is issued may cause its hardware resources to spring to life.

Another embodiment further comprises computer usable program code for migrating at least one of the highest priority virtual machine workloads from a first server to a second server running another one of the highest priority virtual machine workloads, wherein the priority of each individual virtual machine remains associated with the individual virtual machine independent of the migration. The migration has the effect of consolidating high priority workloads on the smallest amount of hardware resources possible, such as a single server. Accordingly, the computer usable program code may set the operating level of each of the plurality of hardware resources within the first server to shut down, or some other appropriately reduced operating level, in response to having migrated the highest priority virtual machine workloads off the first server. As with various other embodiments of the invention, the reduced operating level of hardware resources on the first server will conserve power for use by other hardware resources within the same power domain, such as select hardware resources within the second server that are now running the highest priority virtual machine workloads.

A similar embodiment includes computer usable program code for shutting down all hardware resources that are exclusively associated with low priority (non-critical) workloads in response to a loss of power, and computer usable program code for migrating virtual machines with high priority workloads into the smallest set of physical hardware possible. In other words, the computer usable program code for setting the operating level of each of the plurality of hardware resources includes computer usable program code for setting a low operating level of hardware resources sharing a power domain with a high-priority virtual machine workload, but not participating in execution of the high-priority virtual machine workload. Still further, the computer usable program code for setting the operating level of each of the plurality of hardware resources may include computer usable program code for setting a high operating level to each of the hardware resources participating in the execution of a high-priority workload.

In yet another embodiment, power is supplied to the hardware resources from an uninterruptible power supply (UPS) in response to a loss of power from a primary power source, wherein the uninterruptible power supply generates an alert to a chassis management controller indicating that the system is now running on battery power. A battery alert and an EPOW are both power level warnings, but the latter is more severe than the former. Accordingly, a management entity may respond differently to a battery alert, preferably recognizing that more power and time is available. In one embodiment, as the amount of battery (or other) power wanes, and the ability of the system to safely deal with the power loss decreases, the severity of the management entity's response policy may scale in kind. Optionally, the UPS issues a Simple Network Management Protocol (SNMP) to communicate the alert to components within the power domain, such as the chassis management controller.

In a further embodiment, all of the servers in the system, such as a multi-server chassis, would default to the same EPOW response policy that provides a moderate amount of resiliency. Accordingly, each of the servers would determine operating levels of the hardware resources using the same logic. A workload management agent or hypervisor on each server is also enabled to instigate the creation, deletion and migration of workloads responsive to a user's requirements, as well as determine, by various means, the priority of various workloads. Alternatively, each server could have its own EPOW response policy.

In embodiments that consider the I/O utilization of a workload, the amount of network bandwidth that is being utilized by any one or each of the virtual machines may be determined, since the server is coupled to an Ethernet link of a network switch. The network switch collects network statistics in its management information base (MIB). Optionally, the MIB data may be used to identify the amount of network bandwidth attributable to each virtual machine and is identified according to media access control (MAC) addresses or Internet Protocol (IP) addresses that are assigned to the virtual machines. Data from each network switch MIB may be shared with a management node in each chassis and/or shared directly with the remote management node. Whether the remote management node obtains the network traffic data directly or from the chassis management nodes, the remote management entity has access to all VM network traffic data.

In a still further embodiment, it may be determined whether a second server has sufficient unused resources to operate a virtual machine to be migrated. This determination may include reading the vital product data (VPD) of the second compute node to determine the input/output capacity, the processor capacity, and the memory capacity of the second compute node. Still further, the processor utilization and the memory utilization may be obtained directly from the second compute node. The amount of an unused resource can be calculated by subtracting the current utilization from the capacity of that resource for a given compute node, such as a server. The management controller may determine that some workloads should be shut down as soon as it is practicable, so that their transactions are all complete and saved, and so that they are no longer utilizing hardware resources. Other workloads need maximum up-time and are given the highest priority so that necessary hardware resources remain on until there is absolutely no power left. Other workloads may require power only until they can shut themselves down cleanly. As workloads shutdown to prepare for the outage, it is possible to iteratively power down hardware that is no longer needed. This can continue until the last of the hardware resources stay on until power goes to zero. Optionally, the management controller may set a power policy for itself of “Power on upon AC restore” and then power itself off to let the system or datacenter expire.

In the context of this application, virtual machines may be described as requiring various amounts of resources, such as input/output capacity, memory capacity, and processor capacity. However, it should be recognized that the amount of the resources utilized by a virtual machine is largely a function of the software task or process that is assigned to the virtual machine. For example, computer-aided drafting and design (CADD) applications and large spreadsheet applications require heavy computation and are considered to be processor intensive while requiring very little network bandwidth. Web server applications use large amounts of network bandwidth, but may use only a small portion of memory or processor resources available. By contrast, financial applications using database management require much more processing capacity and memory capacity with a reduced utilization of input/output bandwidth.

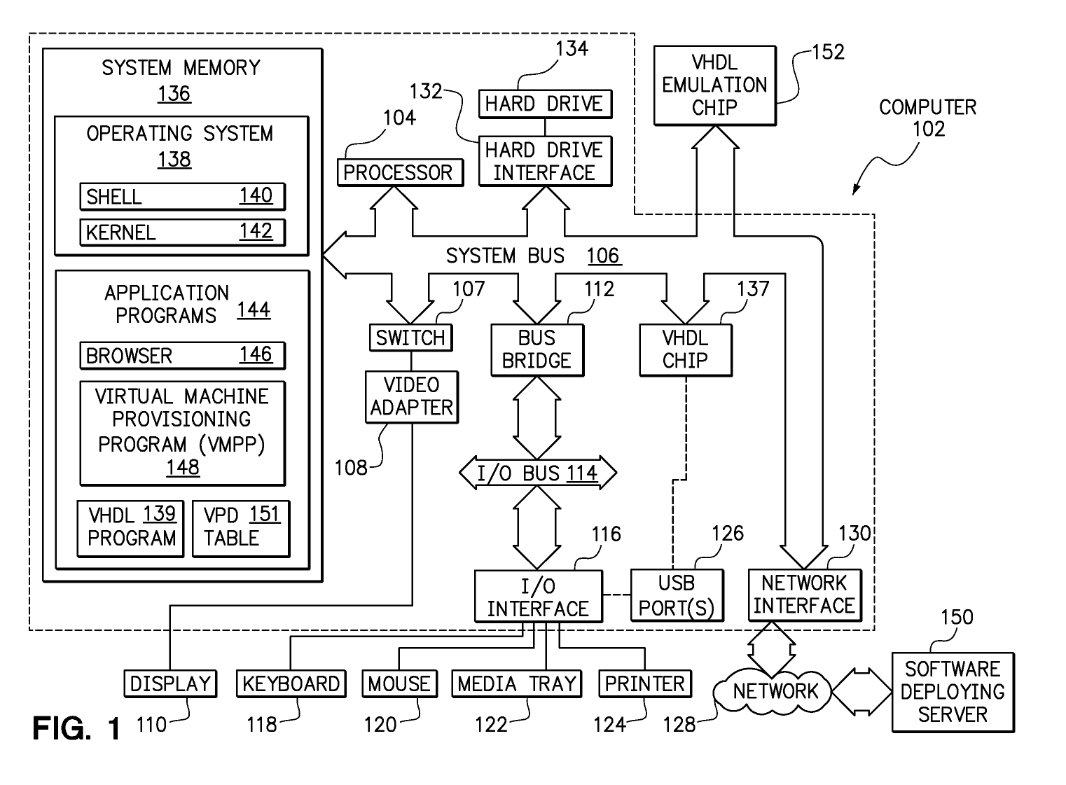

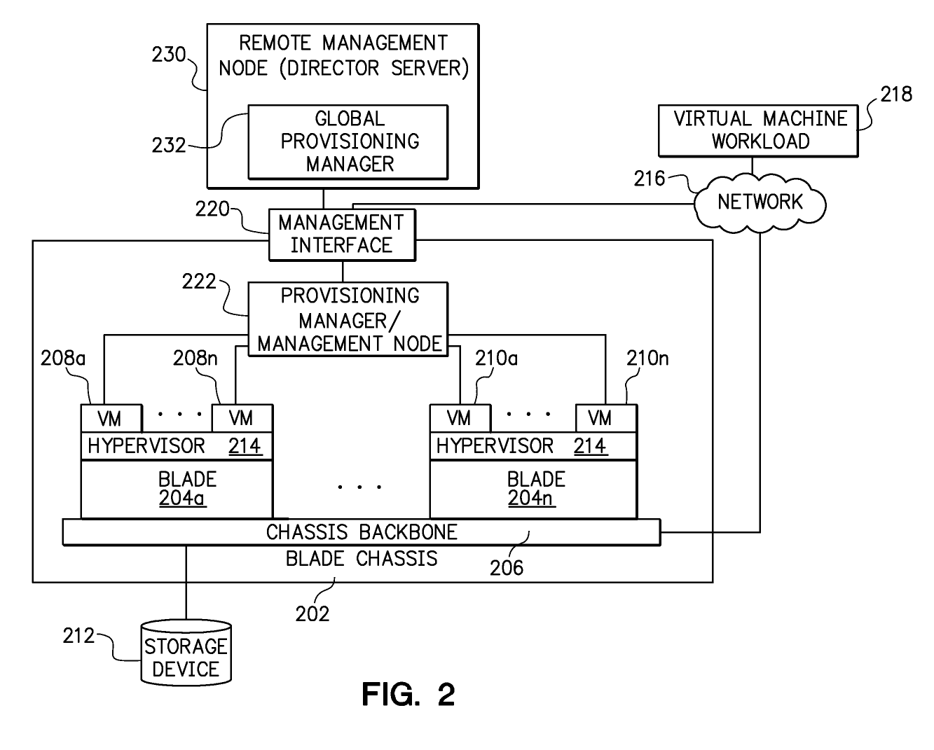

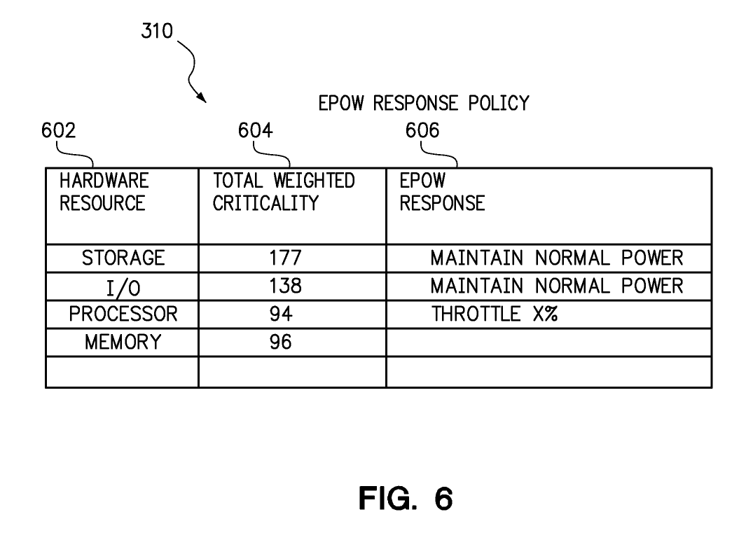

With reference now to the figures, FIG. 1 is a block diagram of an exemplary computer 102, which may be utilized by the present invention. Note that some or all of the exemplary architecture, including both depicted hardware and software, shown for and within computer 102 may be utilized by software deploying server 150, as well as provisioning manager/management node 222, and server blades 204a-n shown below in FIG. 2 and FIG. 6. Note that while blades described in the present disclosure are described and depicted in exemplary manner as server blades in a blade chassis, some or all of the computers described herein may be stand-alone computers, servers, or other integrated or stand-alone computing devices. Thus, the terms “blade,” “server blade,” “computer,” “server,” and “compute node” are used interchangeably in the present descriptions.

Computer 102 includes a processor unit 104 that is coupled to a system bus 106. Processor unit 104 may utilize one or more processors, each of which has one or more processor cores. A video adapter 108, which drives/supports a display 110, is also coupled to system bus 106. In one embodiment, a switch 107 couples the video adapter 108 to the system bus 106. Alternatively, the switch 107 may couple the video adapter 108 to the display 110. In either embodiment, the switch 107 is a switch, preferably mechanical, that allows the display 110 to be coupled to the system bus 106, and thus to be functional only upon execution of instructions (e.g., virtual machine provisioning program—VMPP 148 described below) that support the processes described herein.

System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and (if a VHDL chip 137 is not utilized in a manner described below) external USB port(s) 126. While the format of the ports connected to I/O interface 116 may be any known to those skilled in the art of computer architecture, in a preferred embodiment some or all of these ports are universal serial bus (USB) ports.

As depicted, the computer 102 is able to communicate with a software deploying server 150 via network 128 using a network interface 130. The network 128 may be an external network such as the Internet, or an internal network such as an Ethernet or a virtual private network (VPN).

A hard drive interface 132 is also coupled to the system bus 106. The hard drive interface 132 interfaces with a hard drive 134. In a preferred embodiment, the hard drive 134 communicates with a system memory 136, which is also coupled to the system bus 106. System memory is defined as a lowest level of volatile memory in the computer 102. This volatile memory includes additional higher levels of volatile memory (not shown), including, but not limited to, cache memory, registers and buffers. Data that populates the system memory 136 includes the operating system (OS) 138 and application programs 144 of the computer 102.

The operating system 138 includes a shell 140 for providing transparent user access to resources such as application programs 144. Generally, the shell 140 is a program that provides an interpreter and an interface between the user and the operating system. More specifically, the shell 140 executes commands that are entered into a command line user interface or from a file. Thus, the shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while the shell 140 is a text-based, line-oriented user interface, the present invention will equally well support other user interface modes, such as graphical, voice, gestural, etc.

As depicted, the operating system 138 also includes kernel 142, which includes lower levels of functionality for the operating system 138, including providing essential services required by other parts of the operating system 138 and application programs 144, including memory management, process and task management, disk management, and mouse and keyboard management.

The application programs 144 include an optional renderer, shown in exemplary manner as a browser 146. The browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other described computer systems.

Application programs 144 in the system memory of the computer 102 (as well as the system memory of the software deploying server 150) also include a virtual machine provisioning program (VMPP) 148. The VMPP 148 includes code for implementing the processes described below, including those described in FIGS. 2-6. The VMPP 148 is able to communicate with a vital product data (VPD) table 151, which provides required VPD data described below. In one embodiment, the computer 102 is able to download the VMPP 148 from software deploying server 150, including in an on-demand basis. Note further that, in one embodiment of the present invention, the software deploying server 150 performs all of the functions associated with the present invention (including execution of VMPP 148), thus freeing the computer 102 from having to use its own internal computing resources to execute the VMPP 148.

Optionally also stored in the system memory 136 is a VHDL (VHSIC hardware description language) program 139. VHDL is an exemplary design-entry language for field programmable gate arrays (FPGAs), application specific integrated circuits (ASICs), and other similar electronic devices. In one embodiment, execution of instructions from VMPP 148 causes VHDL program 139 to configure VHDL chip 137, which may be an FPGA, ASIC, etc.

In another embodiment of the present invention, execution of instructions from the VMPP 148 results in a utilization of the VHDL program 139 to program a VHDL emulation chip 152. The VHDL emulation chip 152 may incorporate a similar architecture as described above for VHDL chip 137. Once VMPP 148 and VHDL program 139 program the VHDL emulation chip 152, VHDL emulation chip 152 performs, as hardware, some or all functions described by one or more executions of some or all of the instructions found in VMPP 148. That is, the VHDL emulation chip 152 is a hardware emulation of some or all of the software instructions found in VMPP 148. In one embodiment, VHDL emulation chip 152 is a programmable read only memory (PROM) that, once burned in accordance with instructions from VMPP 148 and VHDL program 139, is permanently transformed into a new circuitry that performs the functions needed to perform the process described below in FIGS. 2-6.

The hardware elements depicted in computer 102 are not intended to be exhaustive, but rather are representative to highlight essential components required by the present invention. For instance, computer 102 may include alternate memory storage devices such as magnetic cassettes, digital versatile disks (DVDs), Bernoulli cartridges, and the like. These and other variations are intended to be within the spirit and scope of the present invention.

FIG. 2 is a diagram of an exemplary multi-server chassis in the form of a blade chassis 202 operating as a “cloud” environment for a pool of resources. Blade chassis 202 comprises a plurality of blades 204a-n (where “n” is an integer) coupled to a chassis backbone 206. Each blade is able to support one or more virtual machines (VMs). As known to those skilled in the art of computers, a VM is a software implementation (emulation) of a physical computer. A single physical computer (blade) can support multiple VMs, each running the same, different, or shared operating systems. In one embodiment, each VM can be specifically tailored and reserved for executing software tasks 1) of a particular type (e.g., database management, graphics, word processing etc.); 2) for a particular user, subscriber, client, group or other entity; 3) at a particular time of day or day of week (e.g., at a permitted time of day or schedule); etc.

As shown in FIG. 2, the blade 204a supports a plurality of VMs 208a-n (where “n” is an integer), and the blade 204n supports a further plurality of VMs 210a-n (wherein “n” is an integer). The blades 204a-n are coupled to a storage device 212 that provides a hypervisor 214, guest operating systems, and applications for users (not shown). Provisioning software from the storage device 212 is loaded into the provisioning manager/management node 222 (also referred to herein as a chassis management controller) to allocate virtual machines among the blades in accordance with various embodiments of the invention described herein. The computer hardware characteristics are communicated from the VPD 151 to the VMPP 148 (per FIG. 1). The VMPP may communicate the computer physical characteristics to the blade chassis provisioning manager 222 to the management interface 220 through the network 216, and then to the Virtual Machine Workload entity 218.

Note that the chassis backbone 206 is also coupled to a network 216, which may be a public network (e.g., the Internet), a private network (e.g., a virtual private network or an actual internal hardware network), etc. The network 216 permits a virtual machine workload 218 to be communicated to a management interface 220 of the blade chassis 202. This virtual machine workload 218 is a software task whose execution is requested on any of the VMs within the blade chassis 202. The management interface 220 then transmits this workload request to a provisioning manager/management node 222, which is hardware and/or software logic capable of configuring VMs within the blade chassis 202 to execute the requested software task. In essence the virtual machine workload 218 manages the overall provisioning of VMs by communicating with the blade chassis management interface 220 and provisioning management node 222. Then this request is further communicated to the VMPP 148 in the generic computer system (See FIG. 1). Note that the blade chassis 202 is an exemplary computer environment in which the presently disclosed system can operate. The scope of the presently disclosed system should not be limited to merely blade chassis, however. That is, the presently disclosed method and process can also be used in any computer environment that utilizes some type of workload management, as described herein. Thus, the terms “blade chassis,” “computer chassis,” and “computer environment” are used interchangeably to describe a computer system that manages multiple computers/blades/servers.

FIG. 2 also shows an optional remote management node 230, such as an IBM Director Server, in accordance with a further embodiment of the invention. The remote management node 230 is in communication with the chassis management node 222 on the blade chassis 202 via the management interface 220, but may communicate with any number of blade chassis and servers. A global provisioning manager 232 is therefore able to communicate with the (local) provisioning manager 222 and work together to perform the methods of the present invention. The optional global provisioning manager is primarily beneficial in large installations having multiple chassis or racks of servers, where the global provisioning manager can coordinate inter-chassis migration or allocation of VMs.

The global provisioning manager preferably keeps track of the VMs of multiple chassis or multiple rack configurations. If the local provisioning manager is able, that entity may be responsible for implementing an EPOW response policy within the chassis or rack and send that information to the global provisioning manager. The global provisioning manager would be involved in migrating VMs among multiple chassis or racks, if necessary, and perhaps also instructing the local provisioning management to migrate certain VMs. For example, the global provisioning manager 232 may build and maintain a table containing the same VM data as the local provisioning manager 222, except that the global provisioning manager would need that data for VMs in each of the chassis or racks in the multiple chassis or multiple rack system. The tables maintained by the global provisioning manager 232 and each of the local provisioning managers 222 would be kept in sync through ongoing communication with each other. Beneficially, the multiple tables provide redundancy that allows continued operation in case one of the provisioning managers stops working.

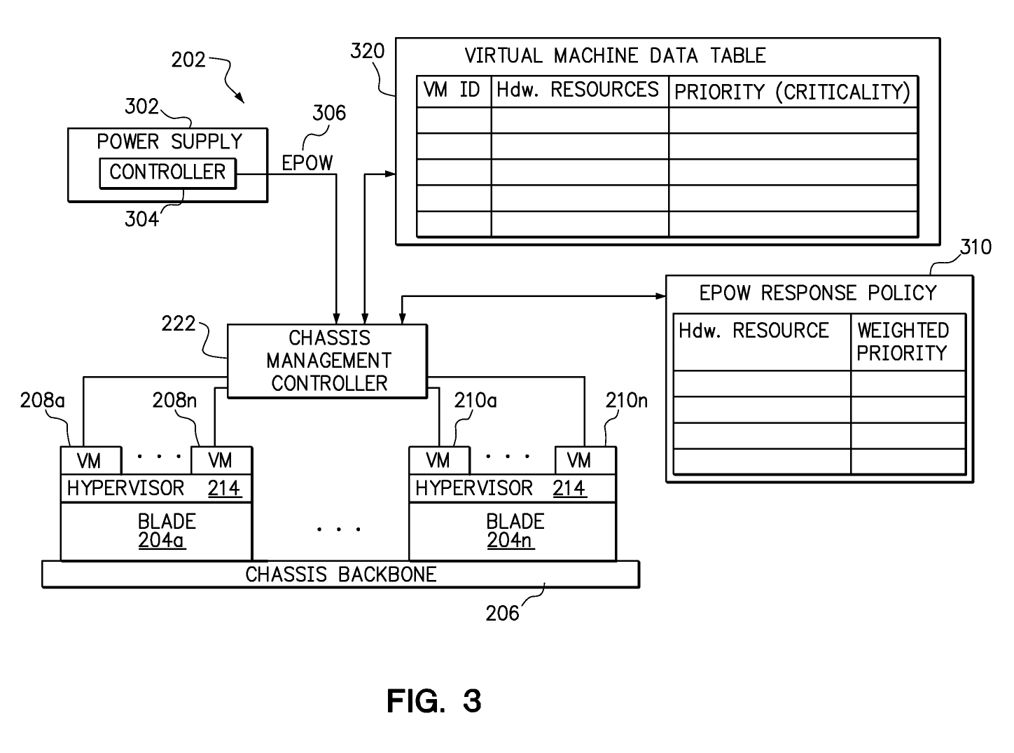

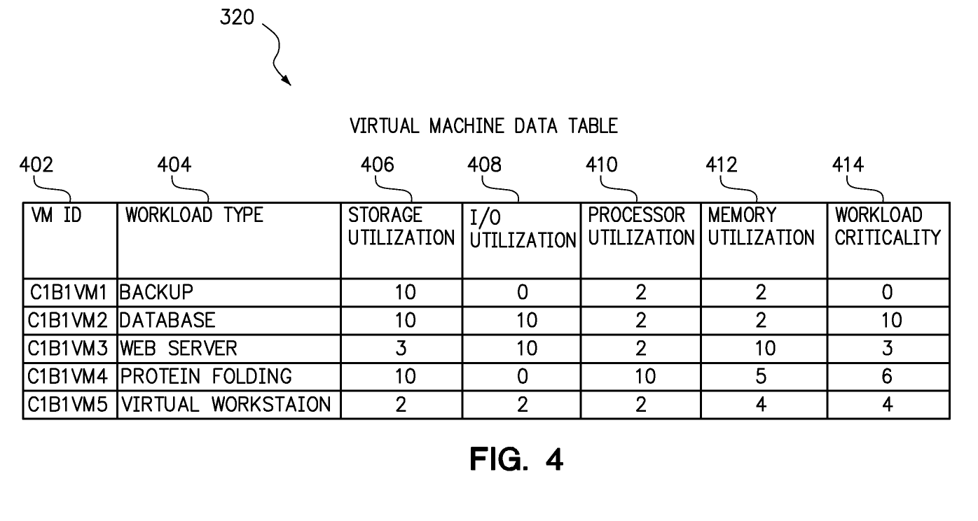

FIG. 3 is a diagram of an exemplary multi-server chassis, consistent with FIG. 2, including a power supply 302. When the power supply 302 detects a loss of incoming power, a power supply controller 304 sends an early power off warning (EPOW) signal 306 to the chassis management controller 222. The chassis management controller 222 is in communication with each of the hypervisors 214 within the chassis, and is able to manage various aspects of virtual machine management on each blade 204a-n, including the migration of virtual machine workloads between the blades. Furthermore, the chassis management controller 222 may run computer readable program code for implementing an EPOW response policy, which is illustrated as an EPOW response policy table 310. In order for the chassis management controller 222 to determine an operating level for each hardware resource within the chassis, data is collected about the various virtual machines running within the chassis, which data is illustrated as a virtual machine data table 320. The contents of the EPOW response policy table 310 and the virtual machine data table 320 will vary according to the specific implementation of one of the embodiment described above. The tables 310, 320 are intended to be generic representations of data and an EPOW response policy, but a specific example will be given with respect to FIGS. 4 to 6, below.

FIG. 4 is a virtual machine data table 320 according to one embodiment. A first column 402 lists virtual machine identifications (VM ID), such as chassis 1, blade 1, virtual machine 1 (“C1B1VM1”). The type of workload that is being handled by the virtual machine is identified in the second column 404. The next four columns provide storage utilization (column 406), I/O utilization (column 408), processor utilization (column 410), and memory utilization (column 412) for each virtual machine. These utilizations may be static, such as user input or determined on the basis of the workload type (column 404), or dynamically determined. Each virtual machine is also associated with a workload priority or criticality in column 414. The virtual machine data table 320 is accessible to the chassis management controller 222 (See FIG. 3) and may be used in determining hardware resource operating levels according to an EPOW response policy.

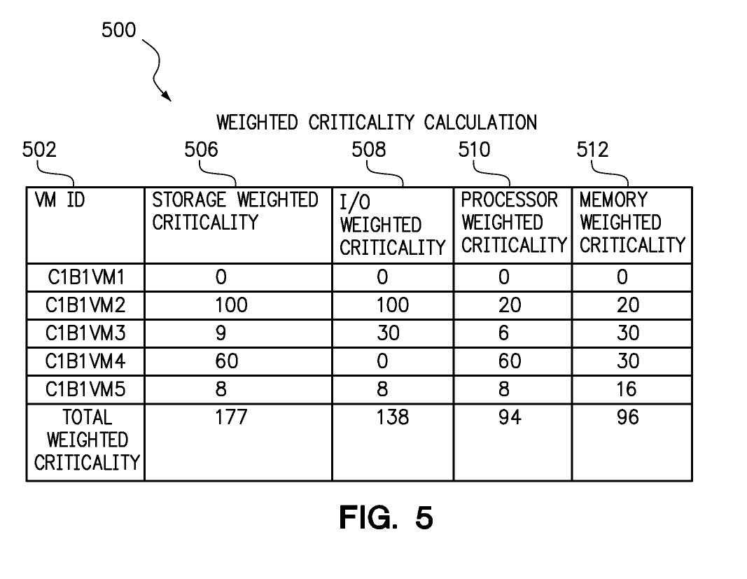

FIG. 5 is a table showing a weighted criticality calculation consistent with the embodiment of FIG. 4. This table 500 is included for illustration purposes to show a weighted criticality calculation according to a specific embodiment. The virtual machine IDs a listed in the first column 502. The next four columns provide storage weighted criticality (column 506), I/O weighted criticality (column 508), processor weighted criticality (column 510), and memory weighted criticality (column 512) for each virtual machine. The weighted criticality values in these four columns 506, 508, 510, 512, correspond to the utilization values in columns 406, 408, 410, 412 in FIG. 4, when the utilization values in FIG. 4 are multiplied by the workload criticality in column 414 of FIG. 4. For example, each of the weighted criticality values for C1B1VM1 are zero (0) because the workload criticality for that VM is zero. The storage weighted criticality for C1B1VM2 is 100, because the storage utilization value of 10 is multiplied by the workload criticality of 10. Each of the VM weighted criticality numbers in columns 506, 508, 510, 512 are calculated in this manner using the VM-specific data in FIG. 4. The bottom row of the weighted criticality calculation table 500 provides a column total for each of the weighted criticality columns 506, 508, 510, 512.

FIG. 6 is a table showing EPOW responses consistent with the embodiment of FIGS. 4 and 5. The EPOW response table 310 lists hardware resources in the first column 602 and sets out the total weighted criticality values (from the bottom row of FIG. 5) in the second column 604. Examining the total weighted criticality values in this manner, it is clear that the most critical hardware resources are storage (value of 177) and I/O (value of 138), whereas the processor (value of 94) and memory (value of 96) are less critical. An appropriate EPOW response is set out for each hardware resource in the last column 606. For example, the total weighted criticality value, or the rank of a workload based on the total weighted criticality value, may be associated with an operating level for each hardware resource. In this case, Storage and I/O will largely stay available, because the database workload in C1B1VM2 is the most important workload and has a high utilization of storage and I/O. Much of the processing power will likely be turned off or throttled, since almost no one needs it except a moderately important protein folding workload in C1B1VM4. As a further example, the system may need storage or I/O to stay available, even when no processor workloads are running, in order to service remote users that are not part of the managed workloads in the datacenter. Such a mission or job, which is not a virtual machine workload, may also be considered in the EPOW response policy and used to determine appropriate operating levels for hardware resources.

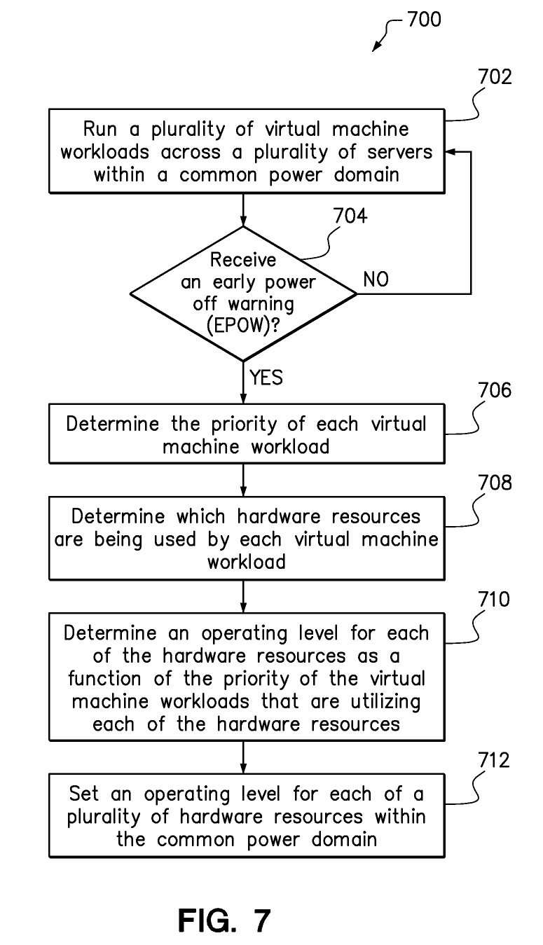

FIG. 7 is a flowchart 700 of one embodiment of the present invention. In step 702, a plurality of virtual machine workloads is run across a plurality of servers within a common power domain. In step 704, it is determined whether an early power off warning (EPOW) has been received from a power supply that provides power within the power domain. If an EPOW has not been received, then the virtual machine workloads continue to run in step 702. If an EPOW has been received, then the priority of each virtual machine workload is determined in step 706, and the hardware resources being used by each virtual machine workload is determined in step 708. In step 710, an operating level is determined for each of the hardware resources as a function of the priority of the virtual machine workloads that are utilizing each of the hardware resources. Then, in step 712, an operating level is set for each of a plurality of hardware resources within the common power domain.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in one or more computer-readable storage medium having computer-usable program code stored thereon.

Any combination of one or more computer usable or computer readable storage medium(s) may be utilized. The computer-usable or computer-readable storage medium may be, for example but not limited to, an electronic, magnetic, electromagnetic, or semiconductor apparatus or device. More specific examples (a non-exhaustive list) of the computer-readable medium include: a portable computer diskette, a hard disk, random access memory (RAM), read-only memory (ROM), an erasable programmable read-only memory (EPROM or Flash memory), a portable compact disc read-only memory (CD-ROM), an optical storage device, or a magnetic storage device. The computer-usable or computer-readable storage medium could even be paper or another suitable medium upon which the program is printed, as the program can be electronically captured via, for instance, optical scanning of the paper or other medium, then compiled, interpreted, or otherwise processed in a suitable manner, if necessary, and then stored in a computer memory. In the context of this document, a computer-usable or computer-readable storage medium may be any storage medium that can contain or store the program for use by a computer. Computer usable program code contained on the computer-usable storage medium may be communicated by a propagated data signal, either in baseband or as part of a carrier wave. The computer usable program code may be transmitted from one storage medium to another storage medium using any appropriate transmission medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable storage medium that can direct a computer or other programmable data processing apparatus to function in a particular manner, such that the instructions stored in the computer-readable storage medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer program product including computer usable program code embodied on a computer usable storage medium, the computer program product comprising:
computer usable program code for running a plurality of virtual machine workloads across a plurality of servers within a common power domain; and
computer usable program code for setting an operating level for each of a plurality of hardware resources within the common power domain in response to receiving an early power off warning from a power source that supplies power to the common power domain, wherein the operating level for each of the hardware resources is determined as a function of the priority of the virtual machine workloads that are utilizing each of the hardware resources.

2. The computer program product of claim 1, wherein priority for each of the plurality of virtual machine is an independently determined scaled value.

3. The computer program product of claim 1, wherein the operating level for at least one of the hardware resources is set to a shutdown in response to determining that the at least one of the hardware resources is not utilized by a high priority virtual machine workloads.

4. The computer program product of claim 1, further comprising:
computer usable program code for determining, for each of the virtual machine workloads, an extent of utilization of each of the hardware resources utilized.

5. The computer program product of claim 4, wherein the operating level for a given one of the plurality of hardware resources is a function of the priority of virtual machine workloads utilizing the given hardware resource and a function of the extent of utilization of the given hardware resource by the virtual machine workloads.

6. The computer program product of claim 5, wherein the operating level for a given one of the plurality of hardware resources is a function of the

7. The computer program product of claim 1, wherein the computer usable program code for setting an operating level for each of a plurality of hardware resources further comprises:
computer usable program code for determining an amount of power remaining;
computer usable program code for selecting one or more of the highest priority virtual machine workloads that can be completed with the amount of power remaining; and
computer usable program code for setting a low operating level for each of the plurality of hardware resources within the compute node that are not running the selected virtual machine workloads.

8. The computer program product of claim 1, wherein the priority of a virtual machine workload is manually input by a user.

9. The computer program product of claim 1, wherein the priority of a virtual machine workload is determined dynamically.

10. The computer program product of claim 1, further including:
computer usable program code for determining that the priority of a workload has changed.

11. The computer program product of claim 10, wherein the computer usable program code for determining that the priority of a workload has changed includes computer usable program code for reducing the priority of the workload in response to determining that the resources executing the workload are in an idle state.

12. The computer program product of claim 10, wherein the computer usable program code for determining that the priority of a workload has changed includes computer usable program code for increasing the priority of the workload in response to determining that the resources executing the workload are in a high utilization state.

13. The computer program product of claim 1, further comprising:
computer usable program code for migrating at least one of the highest priority virtual machine workloads from a first server to a second server running another one of the highest priority virtual machine workloads, wherein the priority of each individual virtual machine remains associated with the individual virtual machine independent of the migration; and
computer usable program code for setting the operating level of each of the plurality of hardware resources within the first server to shut down in response to having migrated the highest priority virtual machine workloads off the first server.

14. The computer program product of claim 1, further comprising:
computer usable program code for shutting down all non-critical hardware exclusively associated with non-critical workloads in response to a loss of power; and
computer usable program code for migrating virtual machines with high priority workloads into the smallest set of physical hardware possible.

15. The computer program product of claim 1, wherein the computer usable program code for setting the operating level of each of the plurality of hardware resources includes computer usable program code for setting a low operating level of hardware resources sharing a power domain with a high-priority virtual machine workload, but not participating in execution of the high-priority virtual machine workload.

16. The computer program product of claim 15, wherein the power domain is a multi-server chassis.

17. The computer program product of claim 15, wherein the low operating level is an immediate hard shutdown.

18. The computer program product of claim 1, wherein the computer usable program code for setting the operating level of each of the plurality of hardware resources includes computer usable program code for setting a high operating level to each of the hardware resources participating in the execution of a high-priority workload.

19. The computer program product of claim 18, wherein the high operating level includes disabling processor throttling.

20. The computer program product of claim 1, further comprising:
computer usable program code for receiving an alert from an uninterruptible power supply, wherein the alert is generated by the uninterruptible power supply in response to a loss of power from a primary power source.
